(19) United States
(12) Patent Application Publication
(10) Pub. No.: US 2014/0339245 A1
(43) Pub. Date: Nov. 20, 2014

(54) FUEL CAP HOLDER

(71) Applicant: Douglas E. Brewster, Harrisville, PA (US)

(72) Inventor: Douglas E. Brewster, Harrisville, PA (US)

(21) Appl. No.: 14/278,066

(22) Filed: May 15, 2014

Related U.S. Application Data
(60) Provisional application No. 61/824,166, filed on May 16, 2013.

(51) Int. Cl. B60K 15/04

(52) U.S. Cl. CPC B60K 15/0406
USPC 220/744

(57) ABSTRACT

Various embodiments of a fuel cap holder are disclosed. In one example embodiment, a fuel cap holder may include a base; and an extension extending from the base; wherein the extension comprises at least one tab oriented to engage at least a portion of a fuel cap; and wherein the extension is operatively connected to the base by at least one fastener.

### CROSS-REFERENCE TO RELATED APPLICATIONS

This application claims priority from U.S. Provisional Patent Application No. 61/824,166, filed on May 16, 2013, which is incorporated by reference herein in its entirety.

### BACKGROUND

Various vehicles, farm equipment, construction equipment, lawn equipment, generators, and the like, include gasoline or diesel engines. These gasoline and diesel engines commonly include fuel tanks with removable fuel caps. The removable fuel caps may be misplaced, dropped, or otherwise damaged when removed from the fuel tanks during the refueling process. Operating any of the various vehicles or other equipment without a fuel cap can cause potentially dangerous situations, including the spilling or uncontrolled combustion of fuel.

A device is needed for retaining a removable fuel cap during the refueling process.

### SUMMARY

In one embodiment, a fuel cap holder is provided, the fuel cap holder comprising: a base; and an extension extending from the base; wherein the extension comprises at least one tab oriented to engage at least a portion of a fuel cap; and wherein the extension is operatively connected to the base by at least one fastener.

In one embodiment, a fuel cap holder system is provided, the system comprising: a vehicle comprising a fuel cap; a base operatively connected to the vehicle; and an extension extending from the base; wherein the extension comprises at least one tab oriented to engage at least a portion of the fuel cap; and wherein the extension is operatively connected to the base by at least one fastener.

In another embodiment, a fuel cap holder is provided, the fuel cap holder comprising: a base; and an extension extending from the base; wherein the extension comprises at least one tab oriented to engage at least a portion of a fuel cap.

### BRIEF DESCRIPTION OF THE DRAWINGS

The accompanying figures, which are incorporated in and constitute a part of the specification, illustrate various example apparatuses and systems, and are used merely to illustrate various example embodiments. In the figures, like elements bear like reference numerals.

FIG. 1 illustrates a perspective view of an example arrangement of a fuel cap holder 100.

FIG. 2 illustrates a side view of an example arrangement of a fuel cap holder 200 retaining a fuel cap 214.

FIG. 3 illustrates a side view of an example arrangement of a fuel cap holder 300 mounted on a vehicle.

FIG. 4 illustrates a side view of an example arrangement of a fuel cap holder 400.

FIG. 5 illustrates a perspective view of an example arrangement of a fuel cap holder 500.

FIG. 6 illustrates a perspective view of an example arrangement of fuel cap holder 500 mounted on a handlebar 616.

FIG. 7 illustrates a top view of an example arrangement of fuel cap holder 500 mounted on handlebar 616 and retaining a fuel cap 714.

FIG. 8 illustrates a side view of an example arrangement of a fuel cap holder 800.

### DETAILED DESCRIPTION

Many vehicles and other equipment include engines having fuel tanks. These fuel tanks often include a removable fuel cap configured to seal the fuel tank's refueling port between the refueling processes. That is, a user wishing to refuel the vehicle's fuel tank removes the removable fuel cap from the fuel tank, adds fuel (typically a liquid or gas) via the refueling port into the tank, and replaces the fuel cap on the fuel tank.

Often, a fuel tank's refueling port includes a raised ridge extending off of the surface of the fuel tank. The raised ridge is typically in a circular configuration, permitting a sealed engagement with the fuel cap when the fuel cap is inserted into or onto the refueling port. In one embodiment, a fuel cap includes a side wall extending off of the lower surface of the fuel cap, configured to extend at least partially about the raised ridge of the fueling port, so as to provide a further means of sealing the fuel tank when the fuel cap is in place. In another embodiment, a fuel cap may include a rubber gasket, O-ring, or other seal device extending from the lower surface of the fuel cap and configured to sealably engage the raised ridge of the fueling port. In one embodiment, the fuel cap's side wall and seal device include different diameters, such that the seal device is encompassed by the side wall with a gap therebetween. The raised ridge of the fuel tank may fit within the gap between the seal device and the side wall when the fuel cap is inserted into or onto the fueling port.

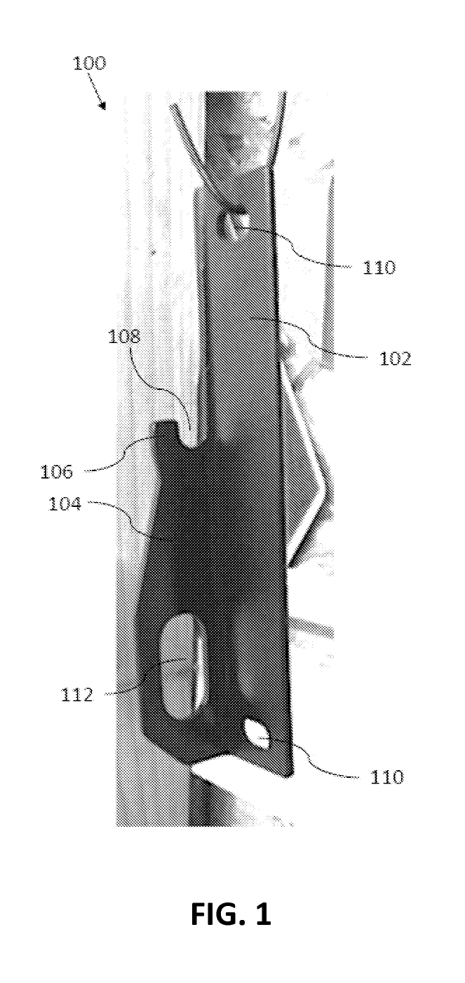

FIG. 1 illustrates a perspective view of an example arrangement of a fuel cap holder 100. Holder 100 may include a base 102 and an extension 104. Extension 104 may include a tab 106 offset from base 102. The offset of tab 106 from base 102 may create a void 108.

Holder 100 may include any of a variety of materials, including for example a metal such as steel, an alloy such as an aluminum alloy, a polymer, or a composite. In one embodiment, at least tab 106 may be covered by at least one layer of a rubber or polymer material to at least one of: aid in retention of a fuel cap, prevent marring of a fuel cap, and prevent marring to surface to which holder 100 is connected.

In one embodiment, base 102 is substantially planar. In another embodiment, base 102 includes a rounded profile configured to substantially match a surface to which base 102 is to be connected, including for example a tubular or cylindrical object. In one embodiment, base 102 is substantially compliant and able to substantially match the shape of a surface to which base 102 is to be connected. In one embodiment, base 102 is configured to be temporarily or permanently connected to any of a variety of objects, including the vehicle or other equipment upon which the fuel tank and fuel cap are mounted, a fuel pump, and a post or other stationary object at a refueling station. In one embodiment, at least one spacer device, such as a washer, may be placed between base 102 and the surface to which it is to be fixed, so as to at least one of: ensure appropriate spacing of tab 106 from the surface, and prevent marring of the surface.

In one embodiment, base 102 includes at least one aperture 110 configured for mounting holder 100 to any of a variety of objects. At least one aperture 110 may receive or engage a fastener, including without limitation at least one of a bolt, a screw, a nail, a rivet, a wire, a cable, a rope, a cable tie, and the like. In one embodiment, base 102 is configured to be affixed to any of a variety of objects via at least one of: a weld, an adhesive, a hook and loop fastener, a magnet, and an epoxy.

Extension 104 may extend from base 102. In one embodiment, extension 104 extends from base 102 at about a 90 degree angle. In another embodiment, extension 104 extends from base 102 at an angle and distance designed to permit clearance of a fuel cap between tab 106 and base 102. In one embodiment, extension 104 is integrally connected to base 102. In another embodiment, extension 104 is removably connected to base 102. In another embodiment, extension 104 is operatively connected to base 102. In another embodiment, extension 104 is pivotally connected to base 102. In another embodiment, extension 104 is configured so as to be as compact as possible while still retaining a fuel cap.

In one embodiment, extension 104 includes an accessory connection point 112. Accessory connection point 112 may include an aperture through at least a portion of extension 104. Accessory connection point 112 may be configured to receive at least a portion of a helmet, such as the strap of a helmet, for attachment of a helmet to a vehicle. In one embodiment, accessory connection point 112 may be configured to receive a portion of anything a user may want to hang therefrom, including a key or tool for removing a fuel cap.

In one embodiment, accessory connection point 112 is configured to act as an anchor point for anchoring a vehicle to another object. In one embodiment, the vehicle to which holder 100 is connected is a motorcycle, ATV, or other wheeled vehicle and accessory connection point 112 is configured to receive a chain, strap, cable, or the like to anchor the vehicle to a trailer or truck during transport. In another embodiment, the vehicle is a boat, and accessory connection point 112 is configured to anchor the boat to an anchor or a dock. In another embodiment, the vehicle is an airplane and accessory connection point 112 is configured to accept a chain, strap, cable, or the like to anchor the vehicle to the ground during windy conditions.

In one embodiment, tab 106 is configured to extend at least partially into a gap between a fuel cap's side wall and seal device, such that the seal device at least partially contacts tab 106. In another embodiment, tab 106 is configured to extend at least partially into a gap between a fuel cap's side wall and seal device, such that the seal device engages at least a portion of tab 106. In one embodiment, a fuel cap includes a rubber gasket, and tab 106 is configured to at least partially deform the rubber gasket, so as to enhance retention of a fuel cap by holder 100. In one embodiment, tab 106 includes a polymer or rubber cover to increase friction between tab 106 and the fuel cap so as to aid in retention of the fuel cap. In one embodiment, holder 100 includes a plurality of tabs 106.

In one embodiment, tab 106 includes dimensions configured to secure a fuel cap such that the center of the fuel cap is substantially normal to tab 106. In one embodiment, tab 106 is substantially flat.

In one embodiment, void 108 is configured to aid in retention of at least a portion of the side wall of the fuel cap. In another embodiment, void 108 is configured to permit passage of the side wall of the fuel cap when tab 106 is inserted into the fuel cap.

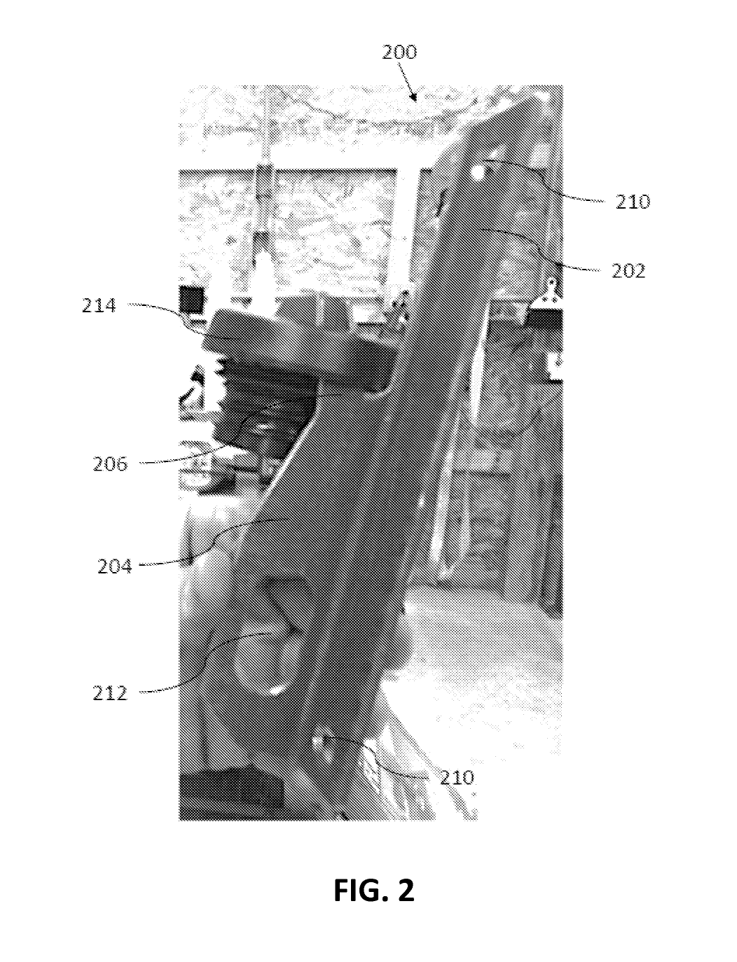

FIG. 2 illustrates a side view of an example arrangement of a fuel cap holder 200. Holder 200 may include a base 202, an extension 204, a tab 206, at least one aperture 210, and an accessory connection point 212.

Holder 200 may be configured to retain a fuel cap 214. Tab 206 may be configured to extend between the side wall of fuel cap 214 and a seal device within fuel cap 214. In one embodiment, fuel cap 214 includes threads, and tab 206 is configured to extend between the side wall of fuel cap 214 and the threads.

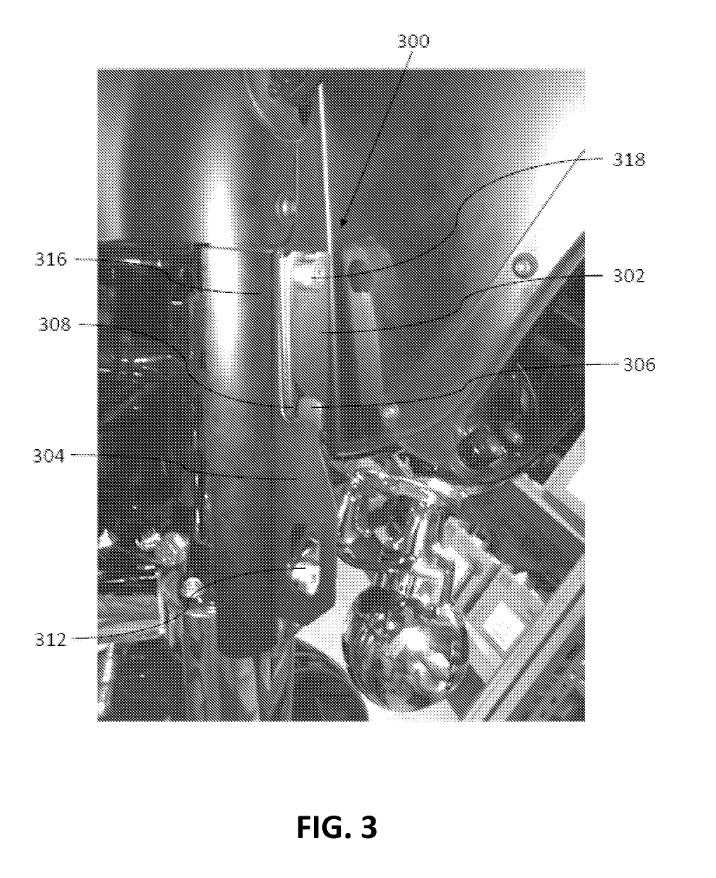

FIG. 3 illustrates a side view of an example arrangement of a fuel cap holder 300. Holder 300 may include a base 302, an extension 304, a tab 306, a void 308, and an accessory connection point 312.

Holder 300 may be operatively connected to a surface of a vehicle 316. In one embodiment, the vehicle is a motorcycle, and surface 316 may be a portion of a front fork assembly for a motorcycle. Holder 300 and base 302 may be connected to surface 316 by at least one fastener 318 extending through base 302 and into surface 316.

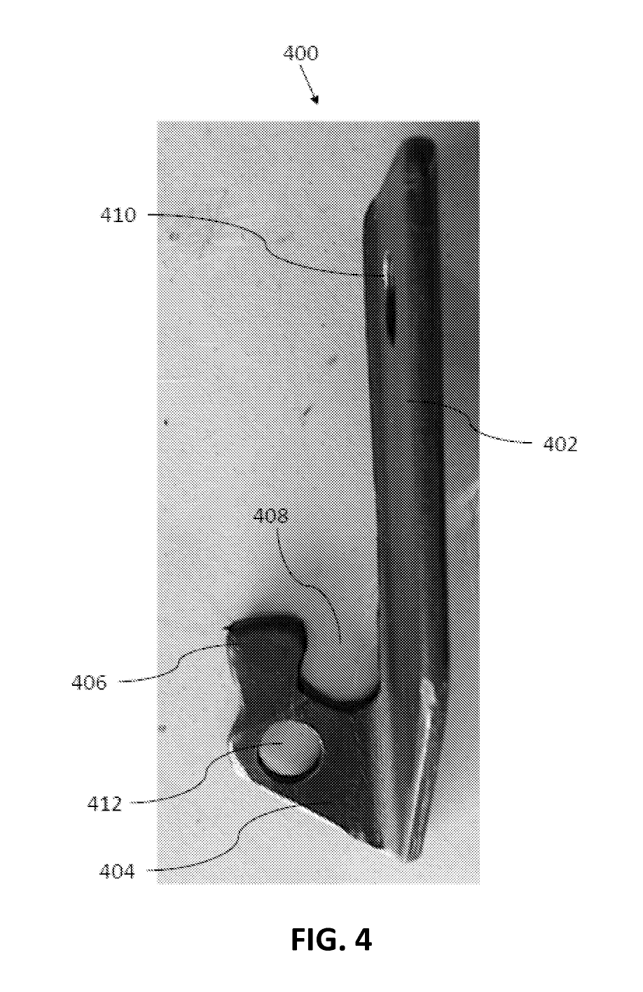

FIG. 4 illustrates a side view of an example arrangement of a fuel cap holder 400. Holder 400 may include a base 402, an extension 404, a tab 406, a void 408, at least one aperture 410, and an accessory connection point 412.

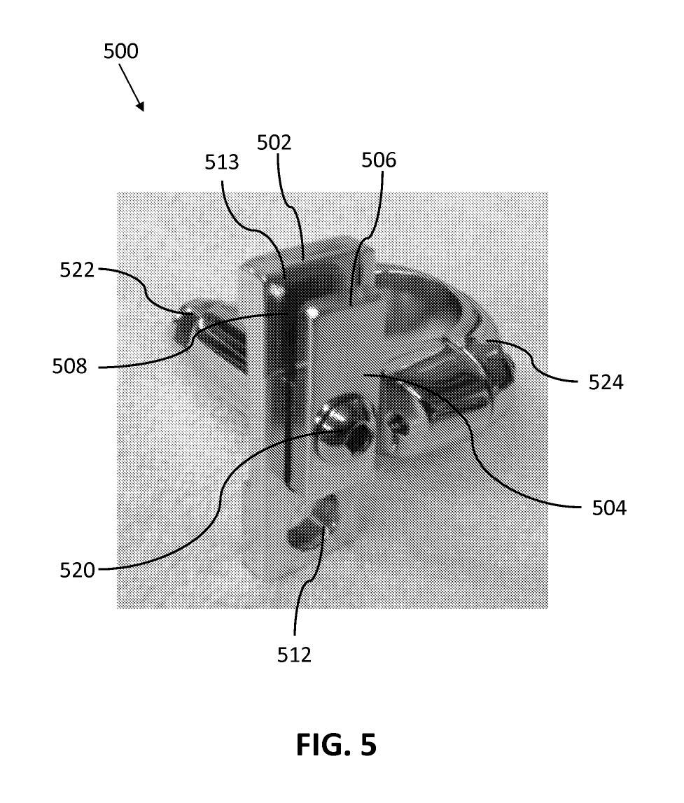

FIG. 5 illustrates a perspective view of an example arrangement of a fuel cap holder 500. Holder 500 may include a base 502 and an extension 504. Extension 504 may include a tab 506 offset from base 502. The offset of tab 506 from base 502 may create a void 508. Holder 500 may include an accessory connection point 512.

Extension 504 may be an independent element separate from base 502. Extension 504 may operatively connect to base 502 by at least one fastener, such as fastener 520. Fastener 520 may include any of a variety of mechanical fasteners, including for example, a screw, a bolt, a nut, a rivet, a pin, and the like. In one embodiment, fastener 520 is a bolt configured to extend through a channel in base 502 and engage a nut 522.

Base 502 may include a channel 513 configured to capture at least a portion of extension 504 and prevent extension 504 from rotating relative to base 502. At least a portion of extension 504 may be configured to fit within, or otherwise engage, channel 513 in base 502 to prevent rotation of extension 504.

Extension 504 may include an offset tab 506, which may act in concert with base 502 to create void 508. Tab 506 may engage a portion of a fuel cap (not shown). A portion of a fuel cap may extend between tab 506 and base 502, which each may engage at least a portion of the fuel cap. The fuel cap may be maintained within void 508 by contacting both tab 506 and base 502 in an unbalanced manner, such that gravity and friction maintain the fuel cap within void 508.

Extension 504 may operatively connect to base 502 in an adjustable manner, such that the dimensions of void 508 may be increased or decreased. For example, extension 504 may be moved away from base 502 so as to increase the width of void 508. Alternatively, for example, extension 504 may be moved closer to base 502 so as to decrease the width of void 508. Void 508 may be configured to accept at least a portion of a fuel cap (not shown). Void 508 may be increased or decreased in dimension to permit acceptance of larger or smaller fuel caps, respectively.

Holder 500 may include a mounting base 524. Mounting base 524 may include any of a variety of devices, mechanisms, elements, or the like configured to selectively, or permanently, attach base 502 to another object. Mounting base 524 may be configured to attach holder 500 to a vehicle. Mounting base 524 may be configured to attach holder 500 to a motorcycle or ATV. Mounting base 524 may be configured to attach holder 500 to a handlebar (not shown) of a motorcycle or ATV. Mounting base 524 may be configured to attach holder 500 to a wall, post, or other structure. Mounting base 524 may be configured to attach holder 500 to a fuel tank. Mounting base 524 may include any of a variety of fasteners, magnets, welds, adhesives, clamps, or the like to mount holder 500 to another object. Mounting base 524 may include a multiple-element device, such as a clamp, for mounting to another element in a clamping manner. Mounting base 524 may include a multiple-element device, such as a clamp, for mounting to a vehicle's handlebar, frame member, forks, or the like, in a clamping manner.

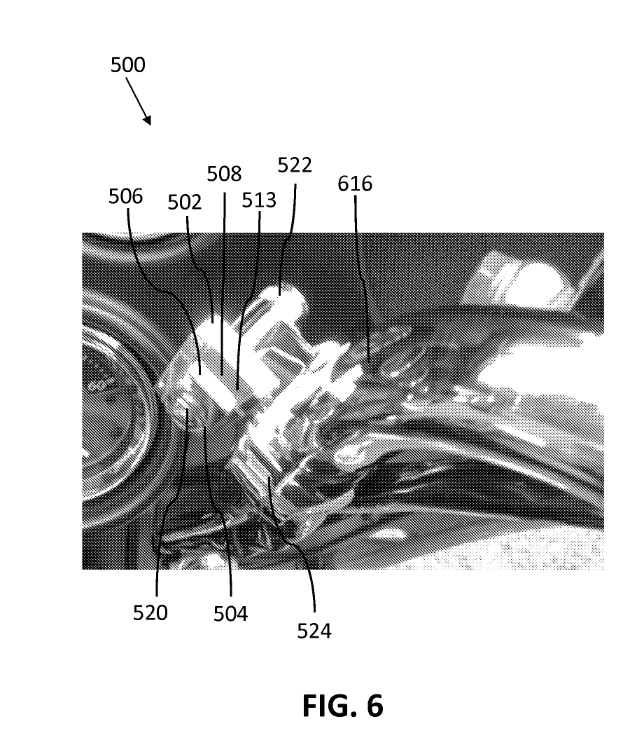

FIG. 6 illustrates a perspective view of an example arrangement of fuel cap holder 500 mounted on a handlebar 616. Holder 500 may include base 502 and extension 504. Extension 504 may include tab 506 offset from base 502. The offset tab 506 from base 502 may create void 508. Holder 500 may include channel 513. Extension 504 may be operatively connected to base 502 via at least one fastener 520. Fastener 520 may engage nut 522.

Mounting base 524 may attach holder 500 to handlebar 616. Mounting base 524 may include a multiple-element device, such as a claim, for mounting to handlebar 616. At least one portion of mounting base 524 may extend on a first side of handlebar 616, while another portion of mounting base 524 may extend on a second side of handlebar 616, wherein the two portions of mounting base 524 are operatively connected to one another.

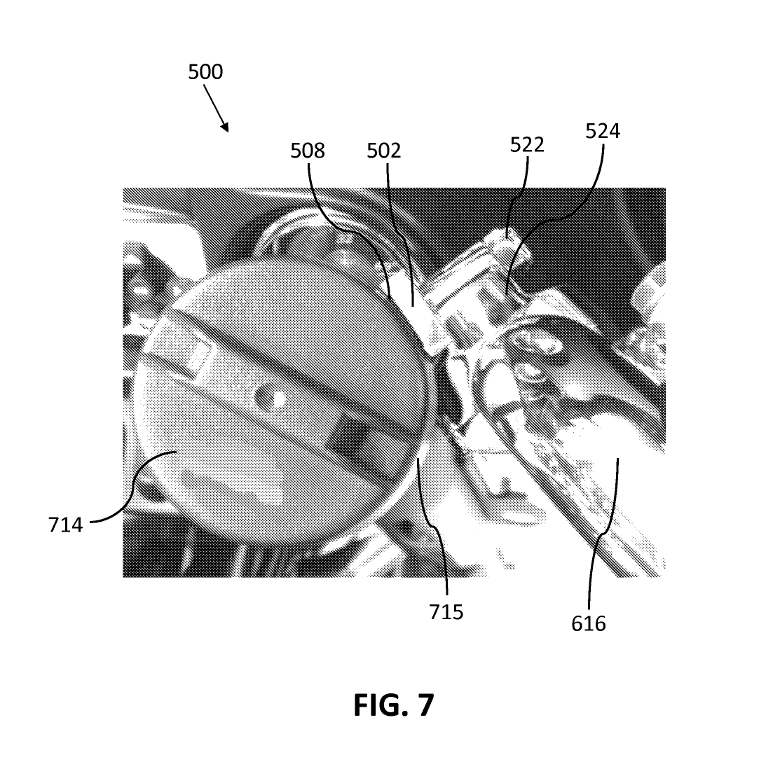

FIG. 7 illustrates a top view of an example arrangement of fuel cap holder 500 mounted on handlebar 616 and retaining a fuel cap 714. Fuel cap 714 may include a side wall 715. Side wall 715 may be oriented within void 508 so as to selectively retain fuel cap 714 in contact with holder 500. Depending upon the thickness of side wall 715, extension 504 may be moved closer to, or farther from, base 502. Extension 504 may be adjusted via manipulation of fastener 520.

Fuel cap 714 may be inserted into holder 500 by a user when the user wishes to retain fuel cap 714 during any activity, including during refueling.

Tab 506 may be configured to extend at least partially between side wall 715 and the remainder of fuel cap 714. Fuel cap 714 may include threads (not shown), and tab 506 may be configured to at least partially extend between side wall 715 and the threads (not shown).

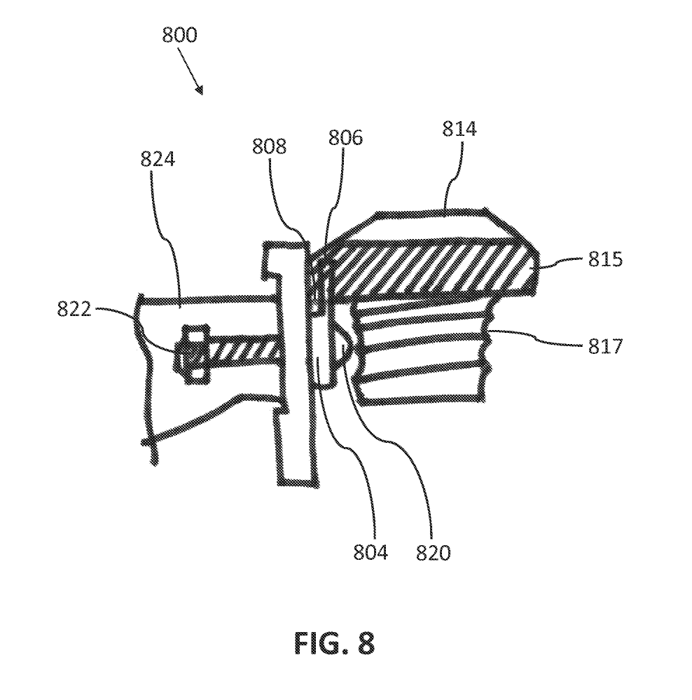

FIG. 8 illustrates a side view of an example arrangement of a fuel cap holder 800. Holder 800 may include a base 802 and an extension 804. Extension 804 may include a tab 806 offset from base 802. The offset of tab 806 from base 802 may create a void 808.

Extension 804 may be operatively connected to base 802 by at least one fastener 820. Fastener 820 may engage a nut 822.

Holder 800 may be configured to engage a fuel cap 814. Fuel cap 814 may include a side wall 815. At least a portion of side wall 815 may extend into void 808. At least a portion of tab 806 may extend between side wall 815 and the remainder of fuel cap 814. Fuel cap 814 may include threads 817. At least a portion of tab 806 may extend between side wall 815 and threads 817.

Side wall 815 may include a thickness. Extension 804 may be moved farther from, or closer to, base 802 to increase or decrease, respectively, the dimension of void 808. Void 808 may be adjusted in size to properly accommodate the thickness of side wall 815.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available in tire manufacturing, which in one embodiment is ±0.25 inches. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A fuel cap holder, comprising:
a base; and
an extension extending from the base;
wherein the extension comprises at least one tab oriented to engage at least a portion of a fuel cap; and
wherein the extension is operatively connected to the base by at least one fastener.

2. The fuel cap holder of claim 1, wherein the base includes a channel, and wherein at least a portion of the extension engages the channel.

3. The fuel cap holder of claim 1, further comprising a void oriented between the at least one tab and the base.

4. The fuel cap holder of claim 1, further comprising a mounting base.

5. The fuel cap holder of claim 4, wherein the mounting base includes a clamp.

6. The fuel cap holder of claim 1, wherein the extension is adjustable relative to the base to increase or decrease the dimension of a void oriented between the at least one tab and the base.

7. The fuel cap holder of claim 1, wherein the at least one fastener is a bolt configured to engage a nut.

8. A fuel cap holder system, comprising:
a vehicle comprising a fuel cap;
a base operatively connected to the vehicle; and
an extension extending from the base;
wherein the extension comprises at least one tab oriented to engage at least a portion of the fuel cap; and
wherein the extension is operatively connected to the base by at least one fastener.

9. The fuel cap holder system of claim 8, wherein the fuel cap comprises a side wall and wherein the at least one tab extends between the side wall and a remainder of the fuel cap.

10. The fuel cap holder system of claim 8, further comprising a void oriented between the at least one tab and the base.

11. The fuel cap holder system of claim 10, wherein the fuel cap comprises a side wall, and wherein at least a portion of the side wall is oriented within the void.

12. The fuel cap holder system of claim 8, further comprising a mounting base.

13. The fuel cap holder system of claim 12, wherein the mounting base includes a clamp.

14. The fuel cap holder of claim 8, wherein the extension is adjustable relative to the base to increase or decrease the dimension of a void oriented between the at least one tab and the base.

15. A fuel cap holder, comprising:
a base; and
an extension extending from the base;
wherein the extension comprises at least one tab oriented to engage at least a portion of a fuel cap.

16. The fuel cap holder of claim 15, wherein the base comprises at least one aperture.

17. The fuel cap holder of claim 15, wherein the extension comprises at least one void.

18. The fuel cap holder of claim 15, wherein the extension extends from the base at about a 90 degree angle.

19. The fuel cap holder of claim 15, wherein the extension is integrally connected to the base.

20. The fuel cap holder of claim 15, wherein the extension is removably connected to the base.
